(19) United States
(12) Patent Application Publication
(10) Pub. No.: US 2015/0015817 A1
(43) Pub. Date: Jan. 15, 2015

(54) LIQUID CRYSTAL DISPLAY DEVICE

(71) Applicant: Sharp Kabushiki Kaisha, Osaka-shi, Osaka (JP)

(72) Inventor: Tsuyoshi Okazaki, Osaka-shi (JP)

(21) Appl. No.: 14/368,551

(22) PCT Filed: Dec. 27, 2012
(86) PCT No.: PCT/JP2012/083962

§ 371 Date: Jun. 25, 2014

(30) Foreign Application Priority Data
Dec. 28, 2011 (JP) 2011-287944

(51) Int. Cl. G02F 1/1337; G02F 1/00; G02F 1/137; G02F 1/1343; G02F 1/1335

(52) U.S. Cl. CPC G02F 1/133753; G02F 1/134363; G02F 1/133528; G02F 1/13439; G02F 1/137; G02F 1/1336; G02F 1/0045; G02F 2001/134372; G02F 2001/133757; G02F 2001/13712; G02F 2001/133531
USPC 349/33

(57) ABSTRACT

A liquid crystal display device (100) according to an embodiment of the present invention operates in a lateral electric field mode, and includes: first and second substrates (50, 60) disposed with a liquid crystal layer (70) interposed therebetween; a first electrode (16) and a second electrode (18) on the first substrate; and a first alignment film (28). The first alignment film includes a first alignment region (A1) in which liquid crystal molecules are to be aligned in a first alignment azimuth and a second alignment region (A2) in which liquid crystal molecules are to be aligned in a substantially orthogonal second alignment azimuth. When a voltage is applied between the first electrode and the second electrode, liquid crystal molecules in the first alignment region and liquid crystal molecules in the second alignment region rotate in an identical direction.

### TECHNICAL FIELD

The present invention relates to a liquid crystal display device, and more particularly to a liquid crystal display device of a lateral electric field mode.

### BACKGROUND ART

Liquid crystal display devices are improving in performance with expansion of their applications. In particular, display modes with wide viewing angle characteristics, e.g., MVA (Multi-domain Vertical Alignment) and IPS (In Plane Switching), have been developed, and are undergoing further improvements.

In recent years, liquid crystal display devices of an FFS (Fringe Field Switching) mode, which is an extended form of IPS mode, have also been developed. In the IPS mode and FFS mode, an electric field is generated in an in-plane direction (or an oblique direction) by using electrodes which are provided on only one of the substrates between which a liquid crystal layer is interposed, and this electric field causes liquid crystal molecules to be rotated in the substrate plane, thus conducting display. These display modes are also referred to as the lateral electric field mode (lateral electric field method).

In a liquid crystal display device of a lateral electric field mode, typically, the liquid crystal molecules during display are aligned in a predetermined azimuth with respect to every pixel. In this case, the difference in refractive index between the major axis direction and the minor axis direction of a liquid crystal molecule results in a problematic color shift (i.e., a specific color appearing more intense or less intense) when viewed from an oblique direction, as compared to when viewed from the front.

Against this problem, Non-Patent Document 1 describes a liquid crystal display device of a dual domain FFS mode in which two domains are provided for each pixel. In the dual domain FFS mode, the two domains are differentiated in terms of electrode structure (specifically, the direction that slits which are made in the pixel electrode extend, etc.) and the direction of the generated electric field. As a result, under an applied voltage, the rotation direction of liquid crystal molecules is reversed from one domain to the other, so that the major axis direction (director) of liquid crystal molecules is unequal between both domains. Moreover, the liquid crystal molecule directors in the two domains are set so that, when displaying white, they are substantially orthogonal to each other. Consequently, on a pixel basis, the liquid crystal molecules are prevented from being observed only in a specific direction (e.g., a direction which is parallel to the major axis direction) thereof, whereby differing apparent retardations are mutually compensated for and thus a color shift is suppressed.

Moreover, Patent Document 1 describes a liquid crystal display device of a lateral electric field mode in which, in an upper pixel region and a lower pixel region within one pixel, elongated electrode portions are provided so as to extend in mutually orthogonal directions. Such an electrode structure also allows electric fields to be generated in substantially orthogonal directions in the upper pixel region and the lower pixel region under an applied voltage, whereby substantially orthogonal liquid crystal molecule alignments can be obtained.

### CITATION LIST

### Patent Literature

[Patent Document 1] Japanese Laid-Open Patent Publication No. 2000-131717

[Patent Document 2] International Publication No. 2009/157207

### Non-Patent Literature

[Non-Patent Document 1] Japanese Journal of Applied Physics Vol. 41(2002) pp. 2944-2948

### SUMMARY OF INVENTION

### Technical Problem

As described above, conventional dual domain liquid crystal display devices are composed so that, under an applied voltage, liquid crystal molecules differ in terms of rotation direction and alignment state from domain to domain. Moreover, through driving such that the major axis directions of the liquid crystal molecules in the respective domains are substantially orthogonal when displaying white, a color shift that is dependent on the viewing angle direction can be suppressed.

However, even if a color shift when displaying white can be compensated for, it has been difficult to compensate for a color shift when displaying a black to any grayscale tone (especially when displaying a low gray scale level) in particular. For example, in the case where the alignment direction of an alignment film is set in one direction through a rubbing treatment or the like, the liquid crystal molecules in each domain have substantially the same alignment direction, in the absence of an applied voltage or under a low voltage. In this case, depending on the angle of viewing (azimuth), the color may appear yellowish or bluish.

The present invention has been made in order to solve the above problems, and an objective thereof is to improve the display quality of a liquid crystal display device of a lateral electric field mode having a plurality of domains, particularly under viewing from an oblique direction.

### Solution to Problem

A liquid crystal display device according to an embodiment of the present invention is a liquid crystal display device of a lateral electric field mode, comprising: a liquid crystal layer; first and second substrates opposing each other with the liquid crystal layer interposed therebetween; first and second polarizers disposed respectively on the first and second substrates; a first electrode and a second electrode disposed on the liquid crystal layer side of the first substrate; and a first alignment film provided on the liquid crystal layer side of the first substrate so as to be in contact with the liquid crystal layer, the first alignment film regulating an alignment azimuth of liquid crystal molecules in the absence of an applied voltage, wherein, the first alignment film has a first alignment region in which the liquid crystal molecules are to be aligned in a first alignment azimuth and a second alignment region in which the liquid crystal molecules are to be aligned in a second alignment azimuth substantially orthogonal to the first alignment azimuth, the second alignment region being adjacent to the first alignment region; and when a voltage is applied between the first electrode and the second electrode, liquid crystal molecules in a first domain corresponding to the first alignment region and liquid crystal molecules in a second domain corresponding to the second alignment region rotate in an identical direction.

In one embodiment, in the first domain the first electrode includes a plurality of elongated first electrode portions or first slits each extending along first electrode direction, and in the second domain includes a plurality of elongated second electrode portions or second slits each extending along a second electrode direction different from the first electrode direction; and when a voltage is applied between the first electrode and the second electrode, in-plane components of generated electric fields in the first domain and the second domain are in different directions.

In one embodiment, the first electrode direction and the second electrode direction constitute an angle of not less than 80° and not more than 100°.

In one embodiment, the first alignment azimuth is offset clockwise from the first electrode direction by a first angle, and the second alignment azimuth is offset clockwise from the second electrode direction by an angle which is substantially equal to the first angle.

In one embodiment, the first electrode includes an electrode portion in “<” shape being bent at a boundary between the first domain and the second domain.

In one embodiment, the liquid crystal layer comprises a nematic liquid crystal material having negative dielectric anisotropy.

In one embodiment, the first alignment film is a photoalignment film.

One embodiment further comprises a backlight unit provided on an opposite side of the first polarizer from the liquid crystal layer, wherein an absorption axis of the first polarizer is substantially parallel to the first alignment azimuth, and a transmission axis of the first polarizer is substantially parallel to the second alignment azimuth.

### Advantageous Effects of Invention

According to an embodiment of the present invention, in a liquid crystal display device of a lateral electric field mode, a color shift under viewing from an oblique direction is suppressed when displaying black and when displaying a grayscale tone, thereby providing an improved display quality.

### BRIEF DESCRIPTION OF DRAWINGS

FIG. 1 A diagram showing enlarged a portion of a liquid crystal display device according to an embodiment of the present invention, where (a) is a plan view showing a region corresponding to one pixel, and (b) is a plan view showing a region corresponding to two pixels.

FIG. 2 A cross-sectional view along line A-A′ in FIG. 1(a).

FIG. 3 A diagram for describing a relationship between the electrode direction, the alignment azimuth, and the like of a liquid crystal display device according to an embodiment of the present invention.

FIG. 4 Showing behavior of liquid crystal molecules within one pixel in the case of using a negative type liquid crystal material, where (a) to (c) show behavior according to an embodiment, and (d) to (f) show behavior according to a comparative implementation.

FIG. 5 Showing behavior of liquid crystal molecules within one pixel in the case of using a positive type liquid crystal material, where (a) to (c) show behavior according to an embodiment, and (d) to (f) show behavior according to a comparative implementation.

FIG. 6 (a) is a diagram showing a pixel construction of a liquid crystal display device according to Comparative Example; (b) shows a pretilt angle of a liquid crystal molecule; and (c) shows coordinate axes for defining a viewing direction.

FIG. 7 A diagram showing wavelength dependence of VT characteristics according to Comparative Example, where (a) corresponds to viewing from the normal direction, and (b) corresponds to viewing from an oblique direction.

FIG. 8 A diagram showing a pixel construction of a liquid crystal display device according to Example.

FIG. 9 A diagram showing wavelength dependence of VT characteristics according to Example, where (a) corresponds to viewing from the normal direction, and (b) corresponds to viewing from an oblique direction.

FIG. 10 A diagram showing wavelength dependence of VT characteristics according to another Example, corresponding to viewing from an oblique direction.

FIG. 11 A diagram showing wavelength dependence of VT characteristics according to still another Example, corresponding to viewing from an oblique direction.

FIG. 12 A diagram for describing a production step for a photoalignment film according to an embodiment of the present invention.

FIG. 13 A plan view showing enlarged a portion of a liquid crystal display device according to another embodiment of the present invention.

FIG. 14 A cross-sectional view showing a liquid crystal display device according to other embodiments of the present invention, where (a) and (b) show different embodiments.

FIG. 15 A diagram showing equipotential lines and alignment directions of liquid crystal molecules in the case where a negative type liquid crystal material is used.

### DESCRIPTION OF EMBODIMENTS

Hereinafter, embodiments of the present invention will be described with reference to the drawings. However, the present invention is not limited to the embodiments described below.

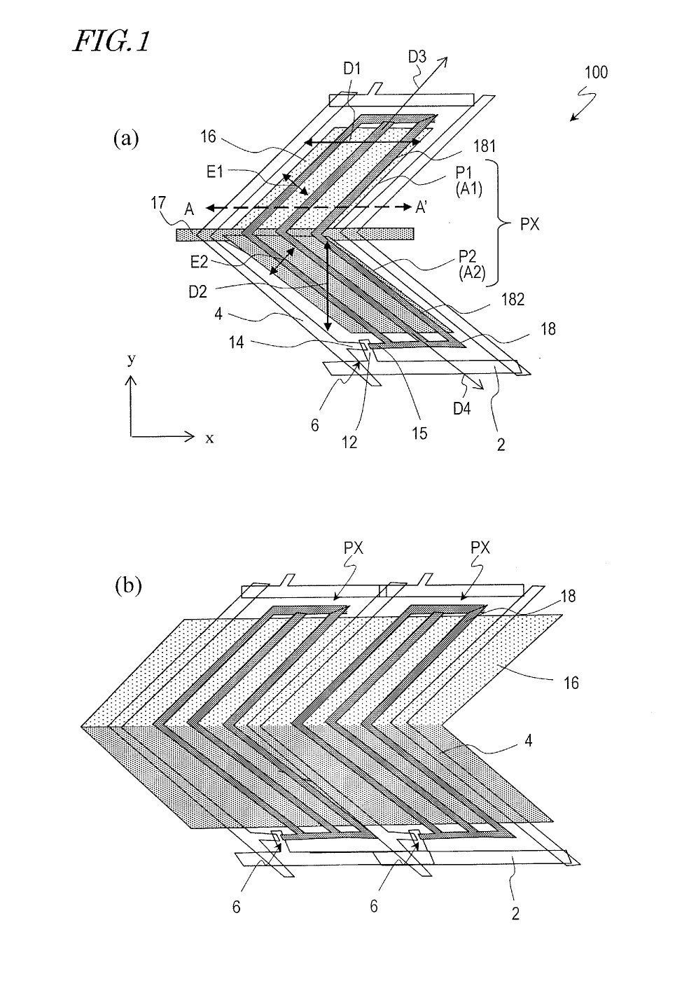

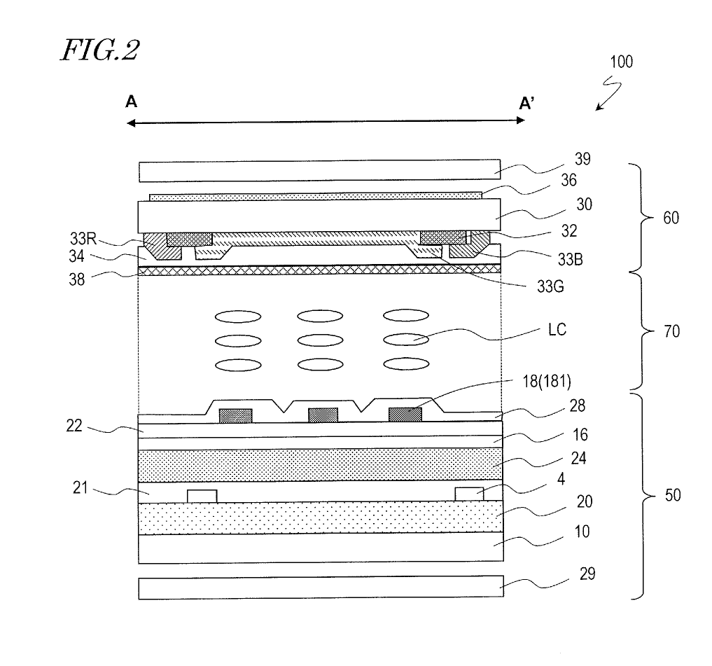

FIG. 1(a) shows enlarged a portion corresponding to one pixel of a direct-viewing type liquid crystal display device 100 of a lateral electric field mode according to an embodiment of the present invention. FIG. 2 is a cross-sectional view along line A-A′ in FIG. 1(a).

As shown in FIG. 2, the liquid crystal display device 100 of the present embodiment includes a TFT substrate 50 and a counter substrate 60 opposing each other, and a liquid crystal layer 70 interposed therebetween. The liquid crystal layer 70 contains a nematic liquid crystal material having negative dielectric anisotropy (which hereinafter may be referred to as a negative type liquid crystal material). The liquid crystal display device 100 of the present embodiment operates in FFS mode, such that displaying is conducted as liquid crystal molecules LC in the liquid crystal layer 70 undergo a rotational motion within the substrate plane in accordance with the direction and magnitude of an applied electric field.

In each of the TFT substrate 50 and the counter substrate 60, a rear-side polarizing plate 29 and a front-side polarizing plate 39 are provided on the opposite side from the liquid crystal layer 70. In the liquid crystal display device 100, the absorption axis of the rear-side polarizing plate 29 and the absorption axis of the front-side polarizing plate 39 (or, alternatively, their respective transmission axes) are in crossed Nicols, i.e., orthogonal to each other, and thus the liquid crystal display device 100 operates in normally black mode.

Moreover, a backlight unit (not shown) which is composed of an LED, a cold cathode-ray tube, or the like is provided on the outside (i.e., the opposite side from the liquid crystal layer 70) of the rear-side polarizing plate 29. Displaying is conducted by allowing light from the backlight unit to be modulated by the liquid crystal layer 70.

As shown in FIG. 1 and FIG. 2, the TFT substrate 50 includes a transparent substrate 10 of glass or the like. On the transparent substrate 10 are provided: gate bus lines 2, source bus lines 4, and TFTs 6 disposed near intersections thereof. Each TFT 6 includes a gate electrode 12 connected to a gate bus line 2, a source electrode 14 connected to a source bus line 4, a drain electrode 15 opposing the source electrode 14 via an interspace, and a semiconductor layer (not shown), which is typically in an island shape, that is connected to the source electrode 14 and the drain electrode 15.

The gate electrode 12 is electrically insulated from the source electrode 14 and the drain electrode 15 by the intervening gate insulating film 20. When an ON voltage is applied to the gate electrode 12, conduction between the source electrode 14 and the drain electrode 15 occurs via the semiconductor layer (channel).

Moreover, the TFT 6 and the source bus line 4 are entirely covered by a first protection film (insulating film) 21. On the first protection film 21, an organic interlayer insulating film 24 is provided to planarize the surface and prevent any unwanted capacitance from being created.

A pixel PX is defined in a region surrounded by two adjacent gate bus line 2 and two adjacent source bus lines 4. In the present embodiment, the gate bus lines 2 extend linearly along the x axis direction as shown in FIG. 1(a), whereas the source bus lines 4 extend in zigzag shapes along the y axis direction. Although not shown in the figure, a plurality of pixels PX are disposed in a matrix shape along the x axis and y axis directions.

In each pixel PX, a common electrode 16 being formed across the entire pixel PX, and a pixel electrode 18 being formed above the common electrode 16 via the second protection film (insulating film) 22, are provided on the organic interlayer insulating film 24. Furthermore, a photoalignment film 28 which is in contact with the liquid crystal layer 70 is provided on the pixel electrode 18, so that the alignment direction of the liquid crystal molecules LC in the absence of an applied voltage are regulated by the photoalignment film 28.

In the present embodiment, each pixel PX includes an upper pixel region (first domain) P1 and a lower pixel region (second domain) P2 which are adjacent to each other along the up-down direction (y axis direction) in FIG. 1(a), thus constituting a dual domain. The upper pixel region P1 and the lower pixel region P2 are shaped as parallelograms which are symmetric to each other, with an axis of symmetry which is the domain border extending along the horizontal direction (x axis direction). Note that the source bus lines 4 are bent at the domain border so as to conform to the shape of the pixel PX.

The pixel electrode 18 provided in the pixel PX has a plurality of bent electrode portions in “<” shape, i.e., a plurality of elongated electrode portions which are bent (or a plurality of bent slits in “<” shape). These electrode portions in “<” shape are composed of elongated portions (first electrode portions) 181 extending along a first electrode direction D3 and elongated portions (second electrode portions) 182 extending along a second electrode direction D4 which is different from the first electrode direction D3. In the first domain P1, the plurality of first electrode portions 181 are arranged in parallel along the first electrode direction D3. In the second domain P2, the plurality of second electrode portions 182 are arranged in parallel along the second electrode direction D4.

The pixel electrode 18, including the plurality of first electrode portions 181 and the plurality of second electrode portions 182, is electrically connected to the drain electrode 15 of the TFT 6 within a contact hole (not shown). A signal voltage from the source bus line 4 is applied to the pixel electrode 18 during an ON period of the TFT 6, whereas a predetermined circuit construction applies common voltage to the common electrode 16 independently of the pixel electrode 18. It will be appreciated the common electrode 16 is insulated from the pixel electrode 18 and the TFT 6.

As shown in FIG. 1(a), the common electrode 16 may have a shape corresponding to one pixel PX. Alternatively, as shown in FIG. 1(b), the common electrode 16 may be provided in common for the plurality of pixels. In the implementation shown in FIG. 1(a), the common electrodes 16 of adjacent pixels are connected via a common bus line 17.

In the present embodiment, the common electrode 16 and the pixel electrode 18 are made of a transparent electrically conductive material such as ITO, and are able to transmit light from the backlight unit (not shown). Moreover, in a portion where the common electrode 16 and the pixel electrode 18 face each other via the second protection film 22, a storage capacitor (auxiliary capacitor) Ccs which is in parallel electrical connection with the liquid crystal capacitor Clc is created. The storage capacitor Ccs appropriately retains the voltage to be applied across the liquid crystal layer during an OFF period of the TFT.

In the TFT substrate 50 thus constructed, electric fields occur in different directions in the first domain P1 and the second domain P2, depending on the voltage which is applied between the pixel electrode 18 and the common electrode 16. In the first domain P1, an electric field E1 occurs which has an in-plane component in a direction substantially orthogonal to the direction (first electrode direction D3) that the first electrode portions 181 (or first slits) extend. In the second domain P2, an electric field E2 occurs which has an in-plane component in a direction substantially orthogonal to the direction (second electrode direction D4) that the second electrode portions 182 (or second slits) extend. In the case where a liquid crystal material having negative dielectric anisotropy is used, the liquid crystal molecules will rotate within the plane so that their minor axis direction runs along the direction of the generated electric field (i.e., the major axis direction of the liquid crystal molecules runs along a direction perpendicular to the electric field).

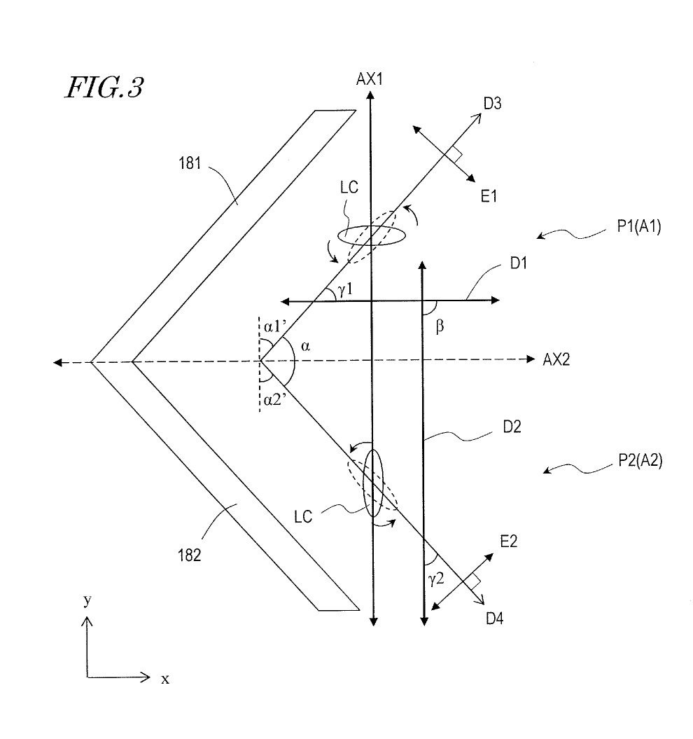

Moreover, the photoalignment film 28 includes a first alignment region A1 and a second alignment region A2 which are provided so as to correspond to the first domain P1 and the second domain P2, respectively. In the first alignment region A1, the liquid crystal molecules are aligned in a first alignment azimuth D1. In the second alignment region A2, the liquid crystal molecules are aligned in a second alignment azimuth D2. In the present embodiment, the first alignment azimuth D1 is a direction substantially parallel to the x axis, whereas the second alignment azimuth D2 is a direction substantially parallel to the y axis. Therefore, the first alignment azimuth D1 and the second alignment azimuth D2 are substantially orthogonal to each other. Moreover, the first alignment azimuth D1 and the second alignment azimuth D2 are set so as to be substantially parallel to a transmission axis AX1 and an absorption axis AX2, respectively, of the rear-side polarizing plate 29 (see FIG. 3).

Now, the aforementioned first alignment azimuth D1 and second alignment azimuth D2 will be described in more detail. The alignment direction of the liquid crystal molecules in the absence of an applied voltage is determined by the alignment regulating force of the photoalignment film 28. This alignment direction (pretilt direction) can be expressed in terms of pretilt angle and pretilt azimuth. In the present specification, a pretilt angle means an angle (rising angle) constituted by the principal face of an alignment film and the major axis direction of a liquid crystal molecule. Moreover, a pretilt azimuth (which hereinafter may also be referred to as an alignment azimuth) means the major axis direction of a liquid crystal molecule within the plane of the alignment film. Unless otherwise specified, the alignment azimuth of a liquid crystal molecule may be either one of the two directions which are 180° apart within the plane. However, in the case where the pretilt angle of a liquid crystal molecule is not 0°, the direction of an in-plane component vector of a pretilt direction (vector) which is defined as a direction of the major axis of the liquid crystal molecule away from the alignment film may be described as the azimuthal direction (one of the alignment azimuths).

In the present embodiment, the photoalignment film mainly functions as a horizontal alignment film that determines the alignment azimuths of the liquid crystal molecules. In the present embodiment, the pretilt angle of the liquid crystal molecules as regulated by the photoalignment film 28 is typically set to 1° or less.

Moreover, in the present specification, a “photoalignment film” means an alignment film to which an alignment regulating force is conferred through irradiation of light (e.g. polarized ultraviolet). Patent Document 2 describes a liquid crystal display device having a photoalignment film, where a technique of forming a photoalignment film by radiating light onto an alignment film which is composed of a polymer having a polyimide main chain and a side chain containing a cinnamate group as a photoreactive functional group, for example, is described.

Next, the counter substrate 60 will be described. As shown in FIG. 2, the counter substrate 60 includes a transparent substrate 30 of glass or the like, a black matrix 32 provided on the transparent substrate 30, and red, green, blue color filters 33R, 33G, and 33B, thus supporting full-color displaying. At the liquid crystal layer 70 side of the transparent substrate 30, an photoalignment film 38 is provided via the organic planarization film 34, the photoalignment film 38 being in contact with the liquid crystal layer 70. Moreover, a transparent conductive film 36 of ITO or the like is provided on the outside (i.e., the opposite side from the liquid crystal layer 70) of the transparent substrate 30 for preventing electrostatic charging.

In the present embodiment, similarly to the photoalignment film 28 provided on the TFT substrate 50, the photoalignment film 38 provided on the counter substrate 60 has a first alignment region A1 and a second alignment region A2 which are disposed corresponding to the first domain P1 and the second domain P2. The alignment azimuths in these alignment regions are set in similar manners to the photoalignment film 28 that is on the TFT substrate 50 side. Moreover, it is preferable that the alignment direction (azimuthal direction) in which the pretilt angle is taken into account differs 180° between the opposing alignment films 28 and 38 (i.e., being of antiparallel relationship).

Next, with reference to FIG. 3, the relationship between alignment azimuths D1 and D2 in the first and second alignment regions A1 and A2, the directions D3 and D4 of the first and second electrode portions 181 and 182, and so on, will be described.

As shown in FIG. 3, an angle β constituted by the first alignment azimuth D1 and the second alignment azimuth D2 is set to substantially 90°. Moreover, the first alignment azimuth D1 and the second alignment azimuth D2 are disposed substantially parallel to the transmission axis AX1 and the absorption axis AX2, respectively, of the rear-side polarizing plate 29. Moreover, as described above, the polarization axis of the front-side polarizing plate 39 and the polarization axis of the rear-side polarizing plate 29 are in crossed Nicols. Therefore, in an initial alignment state in the absence of an applied voltage, the transmittance in each domain P1, P2 is lowest (black).

Moreover, in the first domain P1, the absorption axis AX2 of the rear-side polarizing plate 29 and the alignment azimuth D1 of the liquid crystal molecules LC are substantially parallel; this realizes a mode in which the polarization direction of incident linearly polarized light and the minor axis direction of the liquid crystal molecules LC are substantially parallel. On the other hand, in the second domain P2, the transmission axis AX1 of the rear-side polarizing plate 29 and the alignment azimuth D2 of the liquid crystal molecules LC are substantially parallel; this realizes a mode in which the polarization direction of incident linearly polarized light and the major axis direction of the liquid crystal molecules are substantially parallel. In other words, in the liquid crystal display device of the present embodiment, the two domains realize operations under different modes such that the polarization direction of incident light differs with respect to the major axis direction of the liquid crystal molecules in the absence of an applied voltage.

Moreover, the angle constituted by the first electrode direction D3 and the second electrode direction D4 (also referred to as the inter-electrode angle or electrode bending angle) α is set to 90° in the present embodiment. Accordingly, the angles which the electrode directions D3 and D4 constitute with the pixel up-down direction (y axis direction), which is the direction along which domain adjoin each other (hereinafter referred to as the electrode offset angles), are respectively set to α1′=α2′=45°. However, the inter-electrode angle α is not limited to 90°, and is preferably set in a range from 80° to 100°, as will be described later. At this time, given that the electrode offset angles α1′ and α2′ have the same magnitude, they are preferably 40° to 50°. However, it is not necessary for the electrode offset angles α1′ and α2′ to be equal; one of the electrode offset angles may be set in a range from 30° to 60°, for example.

Moreover, it is preferable that the angles γ1 and γ2 which the alignment azimuths D1 and D2 constitute with the electrode directions D3 and D4 in the respective domains P1 and P2 are substantially equal (i.e., γ1=γ2). The angles γ1 and γ2 are considered to be related to the direction in which the liquid crystal molecules rotate under an applied voltage, how much they rotate, or the angle range in which they are capable of rotating. In the case where the angles γ1 and γ2 are substantially equal, the liquid crystal molecules in the respective domains are capable of rotating in the same direction by about the same amount, in accordance with the levels of applied voltages E1 and E2. This allows the liquid crystal molecules LC in both domains P1 and P2 to rotate, when a voltage of an arbitrary level is applied, so that the initial alignment azimuth relationship (e.g., β=90° is preferably maintained.

Note that Japanese Patent Application No. 2011-266284 by the inventors describes a liquid crystal display device of a lateral electric field mode which displays black when a low voltage on the order of e.g. 0.3 V to 1 V is applied, rather than in the absence of an applied voltage (or under 0 V application). In this liquid crystal display device, the alignment azimuth of the liquid crystal molecules is offset with respect to the polarization axis in the opposite direction from the rotation direction of the liquid crystal molecules by e.g. 1° to 2°. In such construction, under an operation by a gate inversion driving method, for example, a low power consumption and a high contrast ratio can be reconciled by displaying black under a low applied voltage. Such a technique is also applicable to embodiments of the present invention. Therefore, the alignment azimuth D1, D2 and the polarization axis (transmission axis AX1 and absorption axis AX2) in each domain may be offset, so long as the offset is about e.g. 1° or less. In the present specification, they may be expressed as being disposed substantially parallel even if they have such an offset of about 1° or less.

Hereinafter, an operation of the liquid crystal display device of the dual domain FFS mode according to the present embodiment will be described, together with an operation of a liquid crystal display device of Comparative Example.

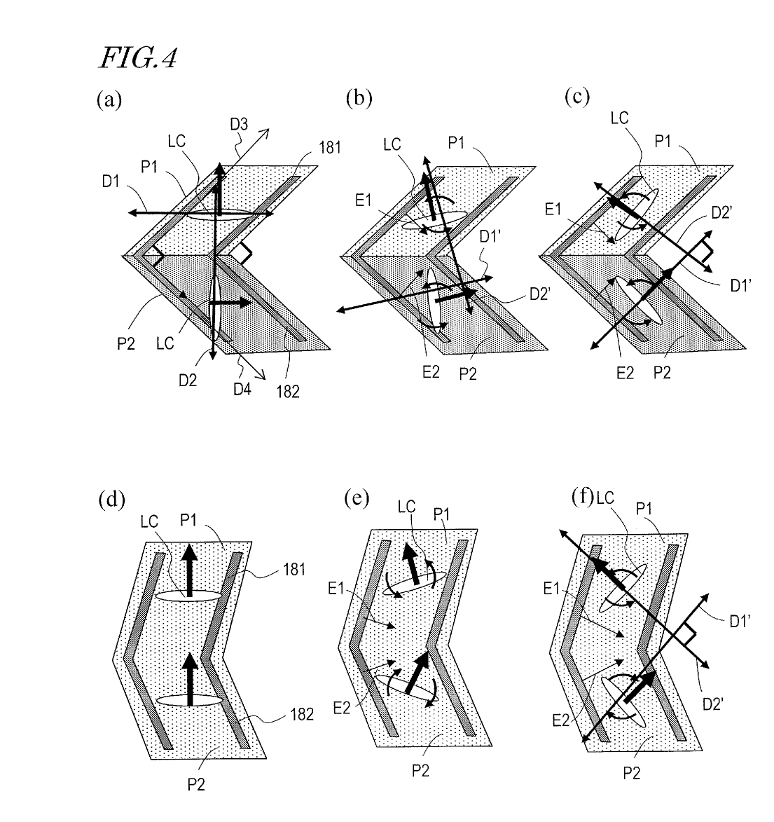

FIGS. 4(a) to (c) respectively show states in the absence of an applied voltage, under an intermediate grayscale voltage (e.g. 3.0 V), under a high voltage (e.g. 7.0 V), of a liquid crystal display device according to an embodiment in which a negative type liquid crystal material is used. FIGS. 4(d) to (f) show states in the absence of an applied voltage, under a low voltage, and under a high voltage, of a liquid crystal display device according to a comparative implementation. For ease of understanding of the figures, the electrode portions in “<” shape, etc., in the central portion of the pixel are omitted in these figures.

As shown in FIG. 4(a), in the liquid crystal display device of the present embodiment, the first alignment azimuth D1 and the second alignment azimuth D2 are respectively set so as to be substantially parallel to the absorption axis AX2 and the transmission axis AX1 of the rear-face polarizing plate 29, in the first domain P1 and the second domain P2. As a result, the major axis directions of the liquid crystal molecules in the two domains are substantially orthogonal.

Moreover, as shown in FIGS. 4(b) and (c), under an applied voltage, an electric field E1 is generated in the first domain P1 which has an in-plane component in a direction substantially perpendicular to the electrode direction D3 of the first electrode portions 181. In actuality, the electric field E1 occurs as an oblique electric field which also has a component in a direction perpendicular to the substrates between the first electrode portions 181 and the common electrode 16. In the second domain P2, an electric field E2 is generated which has an in-plane component in a direction substantially perpendicular to the electrode direction D4 of the second electrode portions 182. In actuality, the electric field E2 occurs as an oblique electric field which also has a component in a direction perpendicular to the substrates between the second electrode portions 182 and the common electrode 16.

In such construction, under an applied voltage, the liquid crystal molecules LC in the first domain P1 rotate counterclockwise due to the electric field E1. Similarly, the liquid crystal molecules LC in the second domain P2 rotate counterclockwise due to the electric field E2. That is, between the first domain P1 and the second domain P2, the rotation directions of the liquid crystal molecules under an applied voltage are identical.

Thus, in the respective domains P1 and P2, the alignment azimuths D1 and D2 are set so as to be substantially orthogonal, and the rotation directions of the liquid crystal molecules under an applied voltage are identical. Therefore, the liquid crystal molecules will rotate in such a manner that the angle constituted by the major axis directions D1′ and D2′ of the liquid crystal molecules is maintained at substantially 90°. As a result, in any arbitrary state of displaying, from when displaying black in the absence of an applied voltage to when displaying a grayscale tone and to when displaying white, differences in apparent refractive index occurring depending on the viewing angle direction (azimuth) can be compensated for, and color shifts can be effectively suppressed.

At the boundary between the domains P1 and P2, the alignment state may differ from that in any other region because the liquid crystal alignment direction greatly varies between the respective domains P1 and P2 and the direction in which an electric field will occur may be different from that of any other region. If this allows leakage of light to be observed when displaying a low gray scale level, for example, the region corresponding to this boundary may be shaded. The method of shading may be, for example, to produce the common bus line 17 shown in FIG. 1(a) by using an electrically conductive material having light shielding ability. Another method may be to dispose a BM (a resin or metal film) on the counter substrate (color filter substrate) with a width of e.g. 5 μm, so as to coincide with the domain boundary.

As described above, the direction in which an electric field will occur at the boundary may differ from that in any other region, but the electric field will not prevent rotation of the liquid crystal molecules in the respective domains. Therefore, since the liquid crystal molecules in the respective domains P1 and P2 are capable of continuously aligning at the boundary, these liquid crystal molecules can be rotated in the same direction.

On the other hand, as shown in FIG. 4(d), in the liquid crystal display device of the comparative implementation, an alignment regulating force which is obtained through a rubbing treatment or the like causes the alignment azimuth to be set in horizontal directions in both domains P1 and P2. In this case, too, as shown in FIG. 4(f), the major axis directions D1′ and D2′ of the liquid crystal molecules will be substantially orthogonal in the respective domains, and thus a color shift when displaying white can be suppressed. However, as shown in FIGS. 4(d) and (e), when displaying black or when displaying a grayscale tone, since the angle constituted by the major axis directions of the liquid crystal molecules is not substantially 90°, a color shift may occur due to changes in the apparent refractive index (or retardation) of the liquid crystal layer 70 when viewed from an oblique direction (or, when changing the direction of viewing). As a result, as compared to when being viewed from the front, the image may be observed as yellowish or bluish, depending on the direction of viewing.

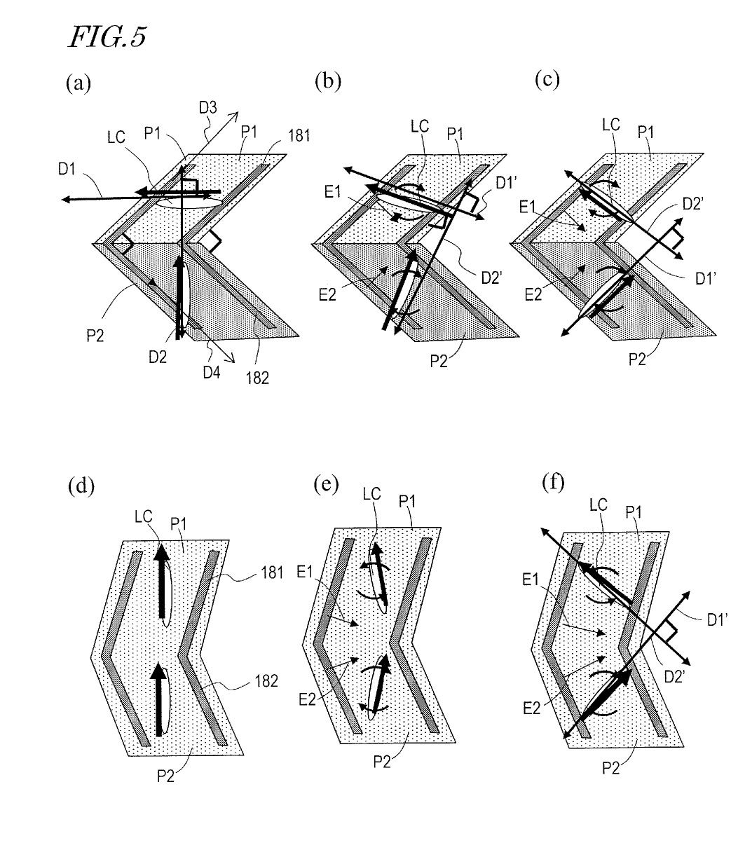

Next, with reference to FIGS. 5(a) to (c) and (d) to (f), states in the absence of an applied voltage, under an intermediate grayscale voltage (e.g. 3.0 V), and under a high voltage (e.g. 7.0 V) will be described with respect to a liquid crystal display device according to another embodiment in which a nematic liquid crystal material having positive dielectric anisotropy (positive type liquid crystal material) is used, and the liquid crystal display device of the comparative implementation.

As shown in FIG. 5(a), also in the case of using a positive type liquid crystal material, similarly to the implementation shown in FIG. 4(a), the first alignment azimuth D1 and the second alignment azimuth D2 are respectively set so as to be substantially parallel to the absorption axis AX2 and the transmission axis AX1 of the rear-face polarizing plate 29, in the first domain P1 and the second domain P2. The first alignment azimuth D1 and the second alignment azimuth D2 substantially orthogonal also in this case.

As shown in FIGS. 5(b) and (c), under an applied voltage, an electric field E1 occurs in the first domain P1, and in the second domain P2 an electric field E2 occurs in a different direction from that of the electric field E1. The liquid crystal molecules LC in the first domain P1 rotate clockwise due to the electric field E1. Similarly, the liquid crystal molecules LC in the second domain P2 also rotate clockwise due to the electric field E2. In other words, the rotation directions of the liquid crystal molecules under an applied voltage are identical between the first domain P1 and the second domain P2.

Thus, the alignment azimuths D3 and D4 in the absence of an applied voltage are set substantially orthogonal, and the liquid crystal molecules rotate in the same direction in both domains under an applied voltage. Therefore, also in the case of using a positive type liquid crystal material, rotation occurs while maintaining a substantially constant angle that is constituted by the liquid crystal molecules. Therefore, under an arbitrary applied voltage, the angle constituted by the major axis directions of the liquid crystal molecules in the respective domains P1 and P2 is maintained at substantially 90°, whereby a color shift can be effectively suppressed in each state.

On the other hand, as shown in FIG. 5(d), in the liquid crystal display device of the comparative implementation, an alignment regulating force obtained through a rubbing treatment or the like causes the alignment azimuths in both domains to be parallel to the vertical direction within the plane. In this case, too, as shown in FIG. 5(f), the major axis directions D1′ and D2′ of the liquid crystal molecules in the domains P1 and P2 are substantially orthogonal, so that a color shift when displaying white can be suppressed. However, as shown in FIGS. 5(d) and (e), when displaying black and when displaying a grayscale tone, since the angle constituted by the major axis directions of the liquid crystal molecules is not substantially 90°, a color shift may occur when viewed from an oblique direction. As a result, as compared to when being viewed from the front, the image may be observed as yellowish or bluish, depending on the direction of viewing.

### Example and Comparative Example

Hereinafter, wavelength dependence of voltage-transmittance characteristics (VT characteristics) of a liquid crystal display device of the conventional FFS mode (Comparative Example) and a liquid crystal display device of Example, in the case where a negative type liquid crystal is used, will be described.

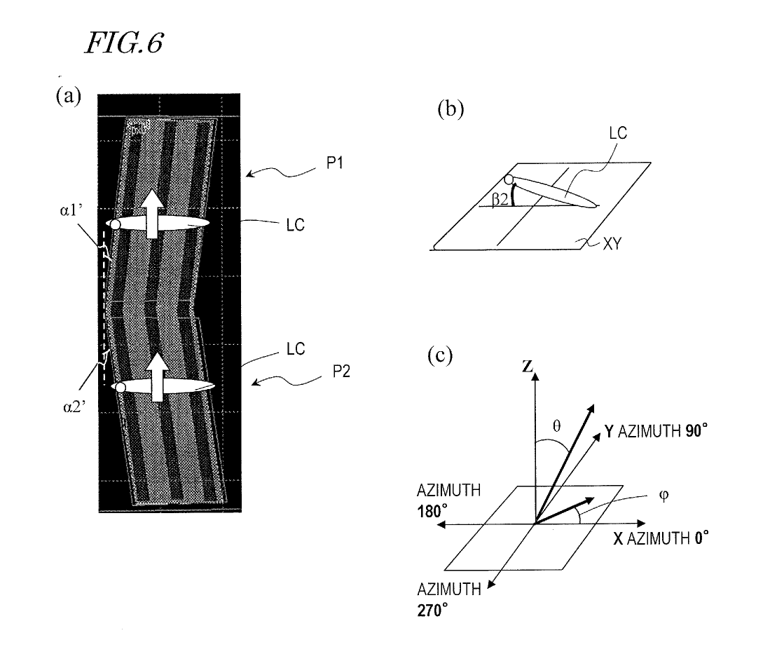

First, Comparative Example will be described. FIG. 6(a) shows the pixel construction of a liquid crystal display device according to Comparative Example. As will be understood from FIG. 6(a), in Comparative Example, the electrode offset angle α1′(=α2′) is set to about 7°. Moreover, in both of the first domain P1 and the second domain P2, the initial alignment azimuth of liquid crystal molecules LC is set in the horizontal direction in the figure. Since a negative type liquid crystal material is used, the liquid crystal molecules will rotate so that the minor axis directions of the liquid crystal molecules are aligned in the direction of an electric field. The minor axis directions of the liquid crystal molecules are indicated by arrows, as directions in which they should align in response to an electric field (directions in which the dielectric constant increases).

As shown in FIG. 6(b), the liquid crystal molecules LC have a pretilt angle β2 (which herein is 0.5°), thus being very slightly upright from the principal face XY of an alignment film. In FIG. 6(a), a small circle indicates the one of the opposite ends of each liquid crystal molecule that is farther away from the alignment film principal face XY. In other words, in Comparative Example, the azimuthal direction of the liquid crystal molecules in each domain P1, P2 is set in a direction of horizontally going from the right to the left in the figure (azimuth 180° indicated in FIG. 6(c)). Such alignment is realized with an alignment film that is obtained with a conventional rubbing treatment in a monoaxial direction, for example.

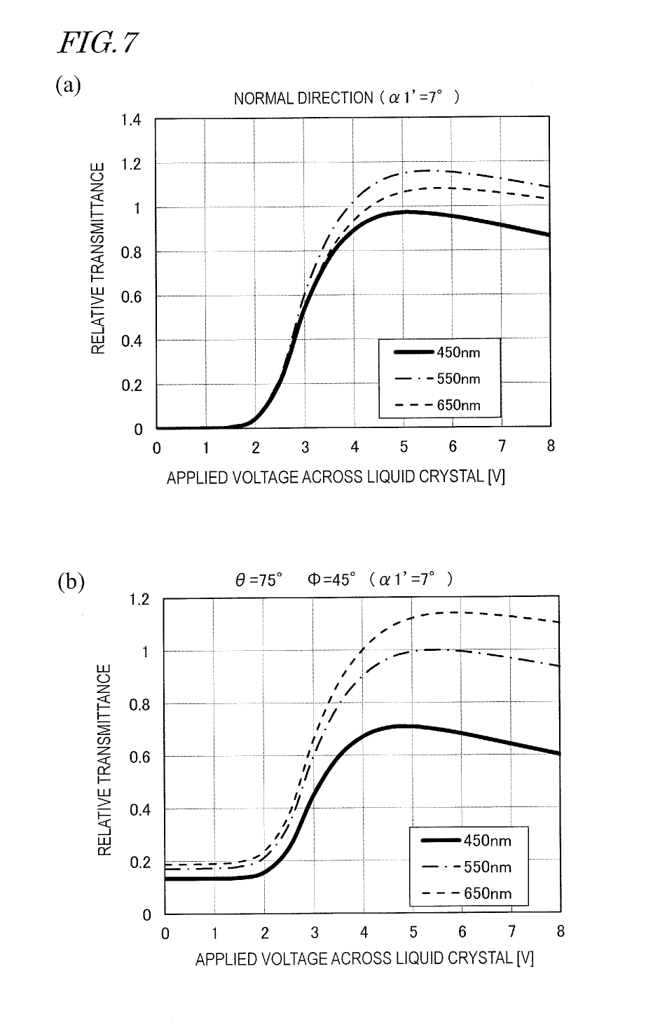

FIG. 7(a) shows voltage-transmittance characteristics (VT characteristics) of Comparative Example, when viewed from the normal direction (the z axis direction shown in FIG. 6(c)). FIG. 7(b) shows VT characteristics of Comparative Example when viewed from an oblique direction with a polar angle θ=75° and an azimuth angle φ=45° (see FIG. 6(c)).

As can be seen from FIG. 7(a), in Comparative Example, the transmittance characteristics for light of wavelengths of 650 nm (red), 550 nm (green), and 450 nm (blue) are relatively similar when displaying a black to any grayscale tone, when viewed from the substrate normal direction. However, as can be seen from FIG. 7(b), under viewing from an oblique direction (θ=75°, θ=45°), the VT characteristics graph are dissimilar depending on the wavelength when displaying a black to any grayscale tone, indicating a phenomenon where certain colors are observed as stronger (or weaker) than under viewing from the front (normal direction). Therefore, a color shift occurs under oblique viewing. Note that transmittance along the vertical axis of the graph is normalized based on the maximum transmittance of light of 550 nm.

At relatively large applied voltages, there is deviation in the VT graphs between the normal direction and the oblique direction. However, the white voltage is likely to be set lower than the maximum-transmittance voltage, and a color shift is relatively unlikely to occur at this voltage. On the other hand, although the wavelength dependence of VT characteristics when displaying white can be set right through a data signal correction based on viewing from the normal direction, some coloring will be observed because of differing characteristics under the oblique direction than under the normal direction.

Next, Example will be described. FIG. 8 shows the pixel construction of a liquid crystal display device according to Example. In the instance shown in FIG. 8, the electrode offset angle α1′(=α2′) is set to 45°, and the electrode bending angle α is set to 90°. In the first domain P1, the alignment azimuth of the liquid crystal molecules is set in the horizontal direction in the figure; in the second domain P2, it is set in the vertical direction in the figure. More specifically, the azimuthal direction of the liquid crystal molecules in the first domain P1 is azimuth 0° shown in FIG. 6(c), whereas the azimuthal direction of the liquid crystal molecules in the second domain P2 is azimuth 90°.

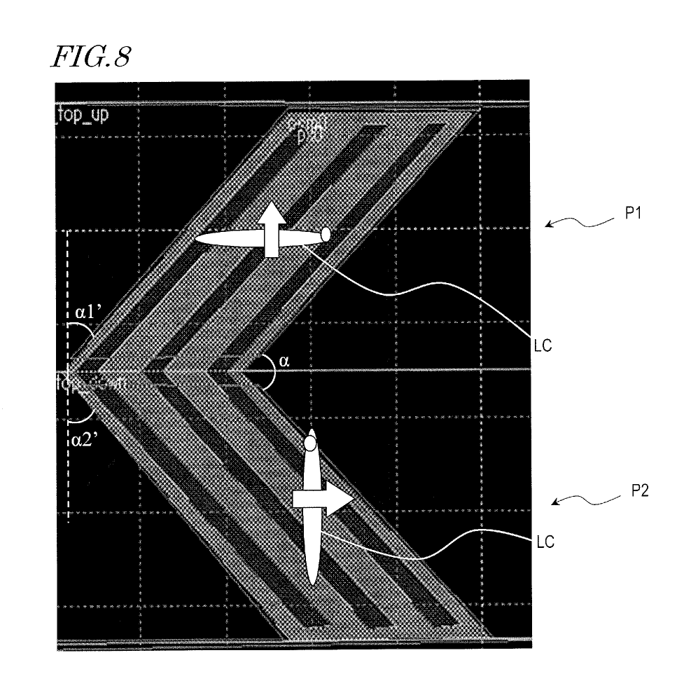

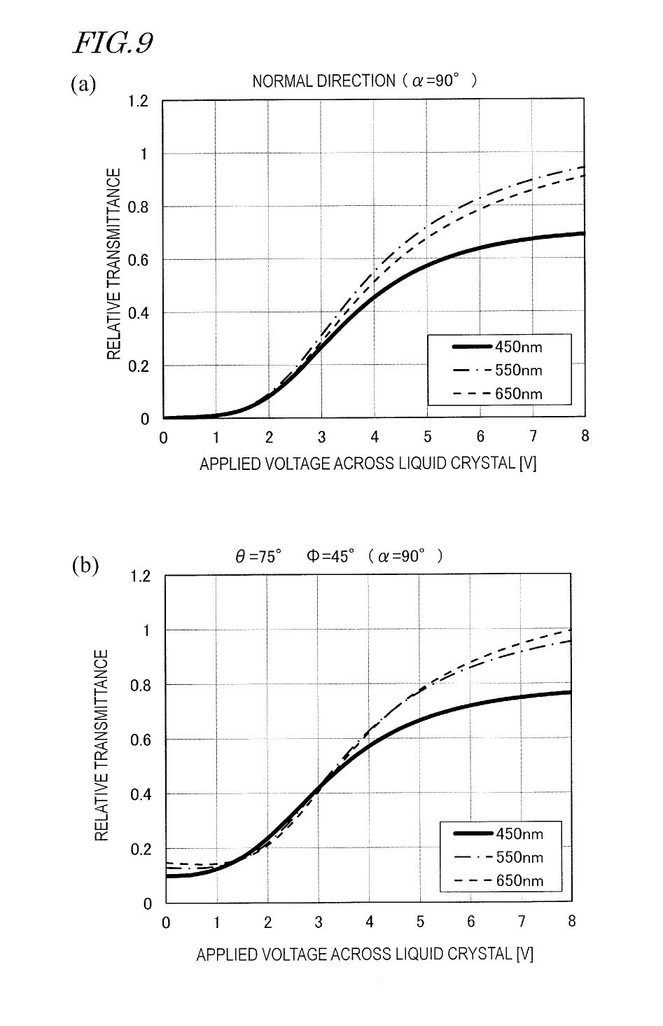

FIG. 9(a) shows voltage-transmittance characteristics (VT characteristics) according to Example when viewed from the normal direction (the z axis direction shown in FIG. 6(c)). FIG. 9(b) shows VT characteristics according to Example when viewed from a direction with a polar angle θ=75° and an azimuth angle φ=45° (see FIG. 6(c)).

As can be seen from FIG. 9(a), according to Example, the transmittance characteristics for light of wavelengths of 650 nm (red), 550 nm (green), and 450 nm (blue) are relatively similar when viewed from the substrate normal direction. Furthermore, as can be seen from FIG. 9(b), the VT characteristics are relatively similar also under viewing from an oblique direction (θ=75°, φ=45°), without wavelength dependence, when displaying a black to any grayscale tone. Therefore, the phenomenon of a specific color being observed as stronger (or weaker) is unlikely to occur, and a similar coloration will be observed when viewed obliquely as well as when viewed from the front, thus suppressing a color shift.

Next, as another Example, cases where the electrode bending angle α constituted by the first electrode direction D3 and the second electrode direction D4 is set to 80° and 100° will be described. Note that the electrode offset angles α1′ and α2′ are 50° and 40°, respectively.

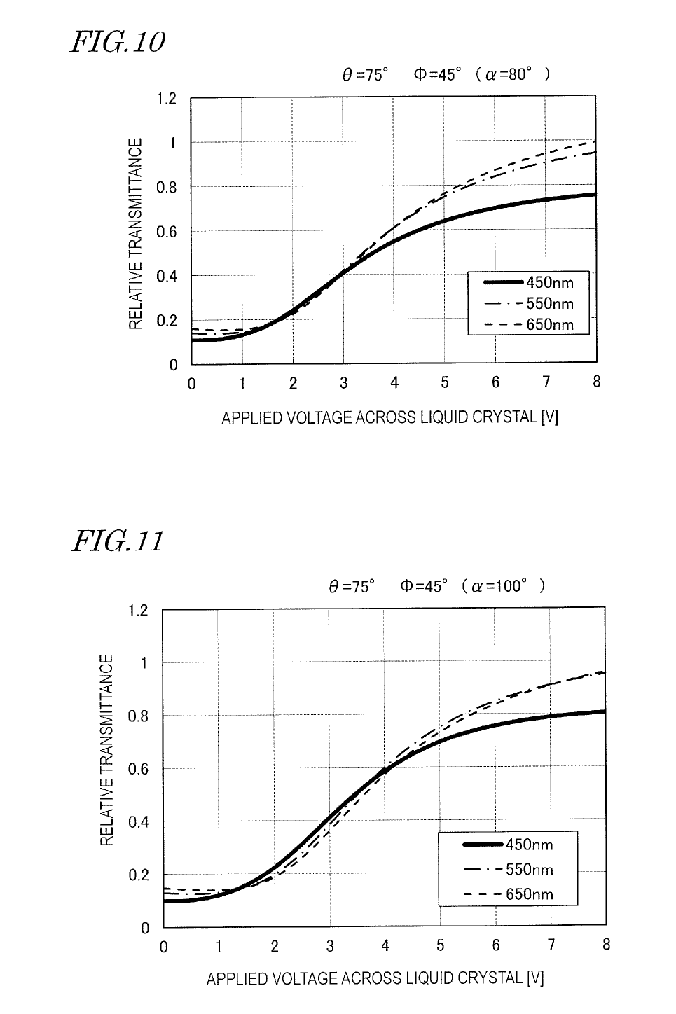

FIG. 10 shows VT characteristics when viewed from an oblique direction (74=75°, φ=45°) in the case where the electrode bending angle α is set to 80°. As can be seen from FIG. 10, wavelength dependence of VT characteristics is relatively low also in this case. Therefore, a similar coloration will be observed when viewed obliquely as well as when viewed from the front, thus suppressing a color shift.

FIG. 11 shows VT characteristics when viewed from an oblique direction (θ=75°, φ=45°) in the case where the electrode bending angle α is set to 100°. As can be seen from FIG. 11, wavelength dependence of VT characteristics is relatively low also in this case. Therefore, a similar coloration will be observed when viewed obliquely as well as when viewed from the front, thus suppressing a color shift.

When the electrode bending angle α was set to 120° or more, in the one domain P2, the angle γ2 between the alignment azimuth D2 and the electrode direction D4 was too small (see FIG. 3) for the liquid crystal molecules to make a rotational motion up to an angle that attains the largest transmittance; thus, there were asymmetric transmittances between the domain P1 and the domain P2 (transmittance loss), so that any operation which would be appropriate for displaying was not realized. Also when the electrode bending angle α was set to 60° or less, a similar phenomenon occurred in the other domain P1, so that any operation which would be appropriate for displaying was not realized. Thus, the electrode bending angle α is preferably greater than 60° and less than 120°, and more preferably not less than 80° and not more than 100°.

Hereinafter, a method of producing of the liquid crystal display device 100 embodiment of the present invention will be described.

The TFT substrate 50 and the counter substrate 60 can be produced by methods similar to conventional ones. However, in the present embodiment, first and second alignment regions A1 and A2 having alignment azimuths which are preferably substantially orthogonal are formed in the photoalignment films 28 and 38; this alignment film formation step will be described with particular focus.

Note that the gate insulating film 20, the first insulating film 21, and the second insulating film 22 of the TFT substrate 50 may be composed of an SiNX film with a thickness of 0.2 μm to 0.5 μm. The gate bus line 2, the source bus line 4, and so on may be composed of a TiN/Al/TiN multilayered metal film with a thickness of 0.4 μm. The organic interlayer insulating film 24 may be made of an acrylic material, to a thickness of 2.5 μm. Moreover, the pixel electrode 18 and the common electrode 16 may be made of ITO, to a thickness of 0.1 μm.

In each domain P1, P2, the pixel electrode 18 includes a plurality of first and second electrode portions 181 and 182 extending in parallel, with their width being set to e.g. about 0.1 μm. The interspace between the first and second electrode portions 181 and 182 (or slit width) may be set to e.g. about 4.0 μm. In the present embodiment, the pixel electrode 18 is formed so that the first and second electrode portions 181 and 182 constitute an angle of 80° to 100°; such a pixel electrode 18 can be easily produced by patterning the electrode by using a resist mask of an appropriate shape in a known electrode patterning step.

Moreover, the black matrix 32 of the counter substrate 60 may be made of a black resin to a thickness of 1.6 μm, and the thickness of the color filters 33R, 33G, and 33B of respective colors is set to 1.5 μm. The organic planarization film 34 is made of an acrylic material to a thickness of 2.0 μm, and the transparent conductive film 36 for preventing electrification may be made of an ITO film with a thickness of 20 nm. The transparent conductive film 36 may be formed by a sputtering technique following the liquid crystal injection step.

Hereinafter, steps of producing the photoalignment films 28 and 38 will be described. In the present embodiment, the first alignment region A1 and the second alignment region A2 whose alignment azimuths are substantially orthogonal to each other are formed on the alignment film 28, 38, so as to correspond to the two domains P1 and P2. Such alignment films are produced as follows, for example.

First, a material for the photoalignment film is applied on the surface of a TFT substrate by a spin coating technique or the like, and is baked, thereby obtaining a transparent resin film having a thickness of e.g. 60 nm to 80 nm. More specifically, the photoalignment film material (e.g. an acrylic chalcone alignment film) is mixed in γ butyrolactone so as to result in a solid concentration of approximately 3.0 wt %, and this is applied on the TFT/counter substrate by using a spin coater, and thereafter the substrate is subjected to a bake treatment on a hot plate, thereby obtaining a resin film. Note that the bake treatment includes a pre-bake (e.g. 1 minute at 80° C.) and a post-bake (e.g. 1 hour at 180° C.). Moreover, the revolutions of the spin coater is appropriately adjusted so as to result in a final film thickness of 60 nm to 80 nm (e.g. 1500 to 2500 rpm).

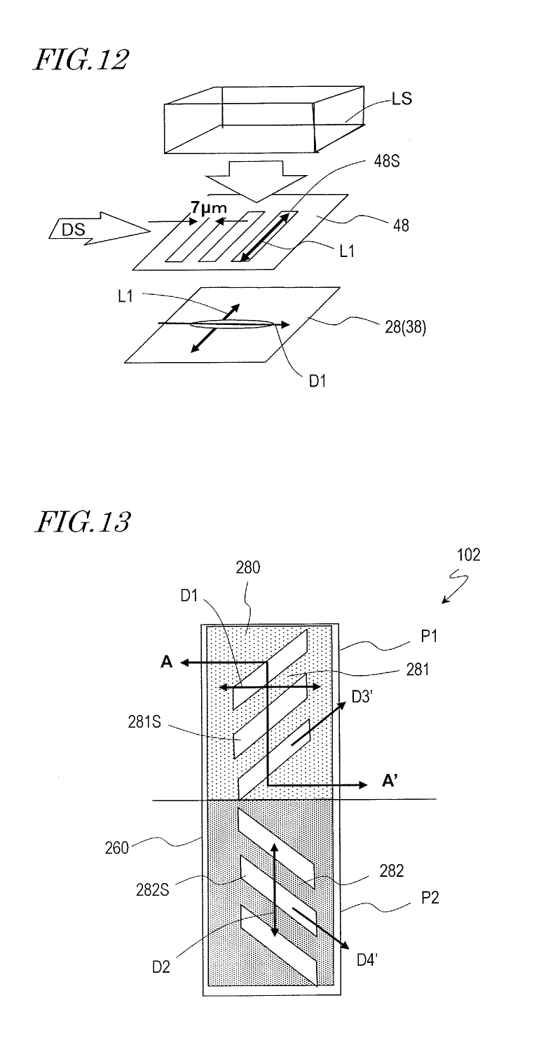

Thereafter, as shown in FIG. 12, via a mask 48 having a plurality of parallel slits 48S in a predetermined direction, the photoalignment film material is irradiated with linearly polarized ultraviolet (polarized UV) having a polarization direction L1, thus forming a photoalignment film. For example, a mask 48 having slits 48s with a width of about 7 μm is disposed between a UV light source LS and the substrate (alignment film 28), and polarized UV is radiated, with the irradiation energy being set at 1.5 J/cm². In doing this, by using the UV light source LS and the slitted mask 48, the substrate may be scanned along the predetermined direction DS at a rate of 35 μm/sec, for example, whereby the entire alignment film can be subjected to an alignment treatment. In the present embodiment, a photoalignment film which exhibits a liquid crystal alignment ability in a direction perpendicular to the direction of irradiation (polarization direction L1) of UV polarized light is used.

At this time, by using a known stepper, the first alignment region A1 (first domain P1) is irradiated with ultraviolet, but the second alignment region A2 (second domain P2) is not irradiated with ultraviolet, whereby an alignment regulating force with the first alignment azimuth D1 (i.e., a direction perpendicular to the polarization direction L1) can be selectively conferred to the first alignment region A1.

Next, by using another mask having a plurality of slits extending in a different direction (substantially orthogonal direction) from that of the slits 48s of the mask 48, the second alignment region A2 is selectively irradiated with ultraviolet whose polarization direction differs by substantially 90° from the ultraviolet with which the first alignment region A1 was irradiated. As a result, a photoalignment film is formed which has different alignment azimuths in the first alignment region A1 and the second alignment region A2.

Thus, use of a photoalignment film is advantageous because it is relatively easy to change the alignment azimuth for each domain by controlling the polarization direction of ultraviolet to be radiated. By using an alignment film thus formed, in a dual domain construction, the major axis directions of the liquid crystal molecules in the respective domains can be aligned so as to be substantially orthogonal in the absence of an applied voltage.

However, it is not necessary to use a photoalignment film to obtain an alignment film having a different alignment azimuth for each domain. For example, while exposing the first domain P1 and covering the second domain P2 with a resist, a rubbing treatment may be conducted in a first direction to form the first alignment region A1; thereafter, the first alignment region A1 may be covered with a resist after the resist is peeled off the second domain P2, and while exposing the second domain P2, a rubbing treatment may be conducted in a second direction (which typically is an orthogonal direction to the first direction) to form the second alignment region A2.

After producing the TFT substrate 50 and the counter substrate 60, a liquid crystal material is sealed in between these substrates to produce the liquid crystal panel. These steps of panel fabrication can also be performed by a known method. To describe a specific example, first, a dispenser is used to apply a sealing material in the periphery of a region of the counter substrate 60 corresponding to one panel. A thermosetting resin can be used as the sealing material.

After applying the sealing material, a pre-bake step (e.g. 5 minutes at 80° C.) is conducted. Moreover, spherical spacers with a desired diameter (which in the present Example is 3.3 μm) are dry spread on the TFT substrate 50. Thereafter, the TFT substrate 50 and the counter substrate 60 are attached together, and after a vacuum pressing step or a rigid pressing step is performed, a post-bake step (e.g. 60 minutes at 180° C.) is conducted.

Usually, a plurality of liquid crystal panels are formed in one piece of large-sized mother glass. Therefore, after the counter substrate 60 and the TFT substrate 50 are attached together, a step of cutting into respective panels is conducted.

In each panel, a gap is formed between the substrates, with an interspace being maintained by spacers. A liquid crystal material is injected into this empty cell. The liquid crystal injection step is conducted by: placing an appropriate amount of liquid crystal material into an injection tray; setting it together with the empty cell in a vacuum chamber; and, after evacuation (e.g. 60 minutes), conducting a dip injection (e.g. 60 minutes). After the cell with the liquid crystal injected therein is taken out of the chamber, the injection inlet is cleaned of any liquid crystal adhering thereto. Moreover, a UV-curing resin is applied on the injection inlet and cured through UV irradiation to seal the injection inlet, thus completing the liquid crystal panel.

In the liquid crystal panel thus fabricated, for example, birefringence Δn=0.10; dielectric anisotropy Δ∈=−5.0 (negative type liquid crystal material); cell thickness d=3.3 μm; and retardation is set to e.g. dΔn=330 nm.

Hereinafter, with reference to FIG. 13, a liquid crystal display device 102 of a dual domain type according to another embodiment having differently shaped pixel electrodes will be described.

In the embodiment shown in FIG. 13, in one rectangular electrode 280 covering both domains, a plurality of parallel slits 281s and 282s are formed so as to be in different directions in the respective domains P1 and P2. Moreover, elongated electrode portions 281 or 282 are present in each domain P1 or P2, in a manner of being sandwiched between adjacent slits 281s or 282s. Similarly to the parallel slits 281s and 282s, the direction in which the elongated electrode portions 281, 282 extend differs between the domains P1 and P2.

The angle constituted by the directions D3′ and D4′ that the slits 281s and 282s (or the electrode portions 281 and 282) extend is preferably 80° to 100°, similarly to the angle constituted by the electrode directions D3 and D4 in the above-described embodiment.

In the present embodiment, too, a first alignment region A1 is provided in the first domain P1 and a second alignment region A2 is provided in the second domain P2 of an alignment film (which preferably is a photoalignment film). In the first alignment region A1, the liquid crystal molecules are aligned in the first alignment azimuth D1 in the absence of an applied voltage. In the second alignment region A2, the liquid crystal molecules are aligned in the second alignment azimuth D2 in the absence of an applied voltage. The first and second alignment azimuths D1 and D2 are substantially orthogonal directions, such that they are preferably substantially parallel to the transmission axis and the absorption axis of the polarizing plate, respectively.

Thus, also in the implementation having the rectangular pixel electrode 280 with the plurality of parallel slits 281s and 282s (and the elongated electrode portions 281 and 282 formed between the slits), the liquid crystal molecules behave so as to rotate in the same direction while maintaining substantially orthogonal alignment azimuths in the dual domain P1, P2. As a result, a color shift under viewing from an oblique direction can be appropriately suppressed even when displaying a black to any grayscale tone.

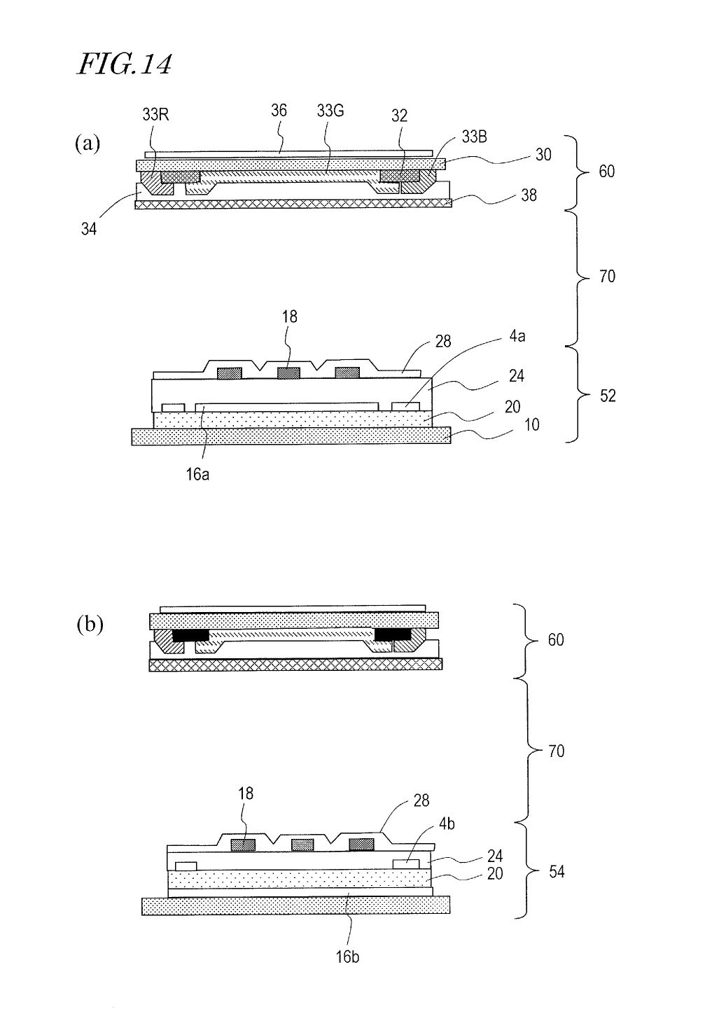

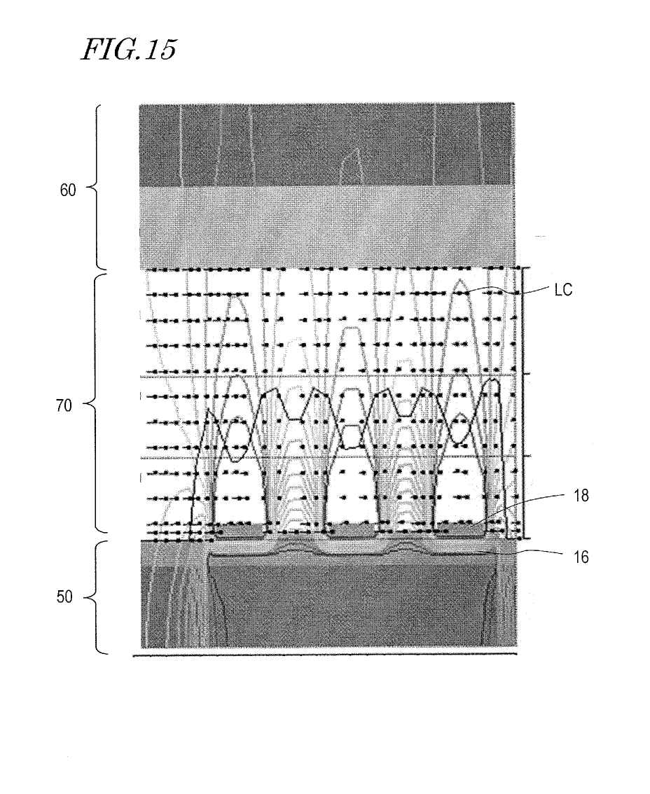

Although embodiments of the present invention have been described, it will be appreciated that various other modifications are possible. For example, as shown in FIG. 14(a), unlike in the implementation shown in FIG. 2, the TFT substrate 52 may be constructed with the source bus lines 4a (and the source electrodes 14 and drain electrodes 15) being provided in the same layer as the common electrodes 16a. Moreover, as shown in FIG. 14(b), the TFT substrate 54 may be constructed with the source bus lines 4b being provided in an upper layer (i.e., a layer between the common electrodes 16b and the pixel electrodes 18) of the common electrodes 16b, and the common electrodes 16 being formed in the same layer as the gate bus lines 2. In FIGS. 14(a) and (b), similar component elements to those of the liquid crystal display device 100 shown in FIG. 2 are denoted by like reference numerals, and their descriptions are omitted.

Moreover, although the above illustrates a liquid crystal display device of a dual domain type in which two domains (and two alignment regions) are created for one pixel, an implementation may be adopted where two domains are created for two adjacent pixels. In this case, in one pixel, one domain is created by the liquid crystal molecules being aligned in a first alignment azimuth; and in a neighboring pixel, another domain is created by the liquid crystal molecules being aligned in a second alignment azimuth which is substantially orthogonal to the first alignment azimuth. In such construction, too, the liquid crystal molecules rotate in the same direction in adjacent pixels under an applied voltage, and when the same voltage of an arbitrary level is applied to the two adjacent pixels, the liquid crystal molecules in the respective pixels take substantially orthogonal states. Note that the two pixels of mutually different alignment azimuths may be flanking along the vertical direction or the lateral direction. Moreover, two or more structures (e.g. structures having bent electrodes (in “<” shape)) each constituting a dual domain may be formed in one pixel.

Although the above mainly illustrates implementations in which a negative type liquid crystal material is used, it is also possible to use a positive type liquid crystal material, as was described with reference to FIG. 5. However, the inventors have confirmed that a desired alignment state may not be obtained with a positive type liquid crystal material, especially in the case where an oblique electric field having an in-plane component and a vertical component is used for driving, as in the FFS mode; the reason is that the liquid crystal molecules will behave so that their major axis directions are aligned in the direction of an electric field. For example, in the case where the azimuths of the liquid crystal molecules are offset by substantially 90° in the respective domains under a low voltage, if a positive type liquid crystal material is used, the VT characteristics when viewed from an oblique direction may deviate depending on the wavelength. This is presumably because a disorder in the liquid crystal alignment occurs as a result of the liquid crystal molecules being aligned so that the major axes of the liquid crystal molecules are in the direction of an oblique electric field. However, even when a positive type liquid crystal material is used, wavelength dependence of VT characteristics can be improved by setting a relatively small (e.g. 270 nm) retardation dΔn.

On the other hand, in the case where a negative type liquid crystal material having negative dielectric anisotropy is used, it is considered that a disorder in liquid crystal alignment is unlikely to occur in response to an oblique electric field. FIG. 15 shows a direction of an electric field and the alignment direction of liquid crystal molecules under an applied voltage. As can be seen from FIG. 15, when a negative type liquid crystal material is used, the major axes of the liquid crystal molecules are in a perpendicular direction to the electric field, and there is relatively little alignment disorder in response to an oblique electric field. Thus, it is preferable to use a negative type liquid crystal material.

The above illustrates implementations in which the alignment azimuth D1 of the liquid crystal molecules in the first domain P1 is substantially parallel to the absorption axis AX2 of the rear-side polarizing plate 29, and in which the alignment azimuth D2 of the liquid crystal molecules in the first domain P1 is substantially parallel to the transmission axis AX1 of the rear-side polarizing plate 29. However, such implementations are not a limitation. In other embodiments of the present invention, the transmission axis and the absorption axis of the rear-side polarizing plate (and the front-side polarizing plate) may be exchanged. In the present specification, a “polarization axis” refers to either one of an absorption axis and a transmission axis. In embodiments of the present invention, the alignment direction of liquid crystal molecules is preferably substantially parallel to the polarization axis (i.e., the absorption axis or the transmission axis) of the rear-side (or front-side) polarizing plate.

Furthermore, the pixel electrode structure is not limited to the structures described in the above embodiments. For example, in a pixel electrode having an outer shape of a rectangle which is longer vertically than horizontally, a plurality of parallel slits extending along the horizontal direction (x axis direction) may be provided in an upper pixel region (first domain), and a plurality of parallel slits extending along the vertical direction (y axis direction) may be provided in a lower pixel region (second domain). In this case, the alignment azimuth in the upper pixel region may be set in a direction which is at an angle of 45° with the slit direction, and the alignment azimuth in the lower pixel region may be set in a direction which is different from the alignment azimuth in the upper pixel region and which is at an angle of 45° with the slits. In this case, the alignment azimuths are 90° apart between the upper pixel region and the lower pixel region. Therefore, a color shift when displaying black can be compensated for. Moreover, under an applied voltage, the rotation directions of the liquid crystal molecules are identical between the respective domains. Therefore, a color shift can be preferably compensated for, when displaying black to white. The polarization axes of the polarizing plates may be set in directions which are parallel to the alignment azimuths of the respective domains.

Although the above illustrates liquid crystal display devices of the FFS mode, a liquid crystal display device of a dual domain IPS mode in which pixel electrodes and common electrodes are provided in the same layer is also applicable.

### INDUSTRIAL APPLICABILITY

A liquid crystal display device according to an embodiment of the present invention is for wide use as various display devices, e.g., medium to small-sized display devices for mobile devices or tablet terminals, large-sized display devices such as TV sets or digital signage, and the like.

### REFERENCE SIGNS LIST

2 gate bus line
4 source bus line
6 TFT
10, 30 transparent substrate
12 gate electrode
14 source electrode
15 drain electrode
16 common electrode
18 pixel electrode
28, 38 photoalignment film
29, 39 polarizing plate
50 TFT substrate
60 counter substrate
70 liquid crystal layer
100 liquid crystal display device
181 elongated portion (first electrode portion)
182 elongated portion (second electrode portion)
P1 first domain (upper pixel region)
P2 second domain (lower pixel region)
A1 first alignment region
A2 second alignment region
D1 first alignment azimuth (pretilt azimuth)
D2 second alignment azimuth (pretilt azimuth)
D3 first electrode direction
D4 second electrode direction
D3′, D4′ slit direction
AX1 transmission axis (polarization axis) of rear-side polarizing plate
AX2 absorption axis (polarization axis) of rear-side polarizing plate
LC liquid crystal molecules
E1, E2 electric field

1. A liquid crystal display device of a lateral electric field mode, comprising: a liquid crystal layer; first and second substrates opposing each other with the liquid crystal layer interposed therebetween; first and second polarizers disposed respectively on the first and second substrates; a first electrode and a second electrode disposed on the liquid crystal layer side of the first substrate; and a first alignment film provided on the liquid crystal layer side of the first substrate so as to be in contact with the liquid crystal layer, the first alignment film regulating an alignment direction of liquid crystal molecules in the absence of an applied voltage, wherein,
the first alignment film has a first alignment region in which the liquid crystal molecules are to be aligned in a first alignment azimuth and a second alignment region in which the liquid crystal molecules are to be aligned in a second alignment azimuth substantially orthogonal to the first alignment azimuth, the second alignment region being adjacent to the first alignment region; and
when a voltage is applied between the first electrode and the second electrode, liquid crystal molecules in a first domain corresponding to the first alignment region and liquid crystal molecules in a second domain corresponding to the second alignment region rotate in an identical direction.

2. The liquid crystal display device of claim 1, wherein,
in the first domain the first electrode includes a plurality of elongated first electrode portions or first slits each extending along a first electrode direction, and in the second domain includes a plurality of elongated second electrode portions or second slits each extending along a second electrode direction different from the first electrode direction; and
when a voltage is applied between the first electrode and the second electrode, in-plane components of a generated electric field in the first domain and the second domain are in different directions.

3. The liquid crystal display device of claim 2, wherein the first electrode direction and the second electrode direction constitute an angle of not less than 80° and not more than 100°.

4. The liquid crystal display device of claim 3, wherein the first alignment azimuth is offset clockwise from the first electrode direction by a first angle, and the second alignment azimuth is offset clockwise from the second electrode direction by an angle which is substantially equal to the first angle.

5. The liquid crystal display device of claim 2, wherein the first electrode includes an electrode portion in “<” shape being bent at a boundary between the first domain and the second domain.

6. The liquid crystal display device of claim 1, wherein the liquid crystal layer comprises a nematic liquid crystal material having negative dielectric anisotropy.

7. The liquid crystal display device of claim 1, wherein the first alignment film is a photoalignment film.

8. The liquid crystal display device of claim 1, further comprising a backlight unit provided on an opposite side of the first polarizer from the liquid crystal layer, wherein
an absorption axis of the first polarizer is substantially parallel to the first alignment azimuth, and a transmission axis of the first polarizer is substantially parallel to the second alignment azimuth.
